(19) United States
(12) Patent Application Publication
(10) Pub. No.: US 2026/0180995 A1
(43) Pub. Date: Jun. 25, 2026

(54) Safety-Critical Monitoring

(71) Applicant: Arm Limited, Cambridge (GB)

(72) Inventors: Kasper William Olof Ornstein Mecklenburg, Santa Cruz, CA (US); Matthew Brian Spencer, Belsham (GB)

(73) Assignee: Arm Limited, Cambridge (GB)

(21) Appl. No.: 18/987,784

(22) Filed: Dec. 19, 2024

(51) Int. Cl. H04L 9/40; H04L 67/12

(52) U.S. Cl. CPC H04L 63/123; H04L 63/30; H04L 67/12

(57) ABSTRACT

A monitoring system for high-integrity monitoring of a safety-critical target system comprises an interface for receiving messages from a target system according to a publish-subscribe communication protocol, and one or more processors. The monitoring system is configured to access configuration data representing one or more expected timing characteristics for a succession of messages that are to be published by the target system in accordance with the publish-subscribe communication protocol and to subscribe, using the publish-subscribe communication protocol, to receive the succession of messages. The monitoring system receives the succession of messages, each comprising a respective publication timestamp, at the interface, and uses the configuration data to determine whether the publication timestamps of the received succession of messages are consistent with the expected timing characteristics. If the publication timestamps of the received succession of messages are not consistent with the expected timing characteristics, the monitoring system signals an inconsistency.

### TECHNICAL FIELD

The present disclosure relates to a monitoring system for high-integrity monitoring of a safety-critical target system.

### BACKGROUND

Computing platforms in safety-critical applications, e.g. for use in automated (e.g. autonomous) driving systems, require processing systems with high reliability. In these systems, the reliable detection of application runtime faults can help achieve system safety goals.

One existing, known way in which application runtime faults may be detected is through the provision of a “safety island”, i.e. a compute sub-system that is separate from a central processing unit (CPU). A critical-application monitor executing on the safety island may be used to monitor a safety-critical application executing on the central processing unit. The safety-critical application can be instrumented so that it issues safety-monitoring signals, as tasks are performed by the application, over one or more socket-based communication channels between the application and the critical application monitor. The critical application monitor checks for these safety-monitoring instrumentation signals and raises a flag if the application does not run in an expected fashion. The system can then take appropriate action, e.g. restarting the safety-critical application.

Existing approaches for critical application monitoring require that instrumentation be provided in the critical applications being monitored. This is undesirable. For instance, it can cause issues with compliance with regulatory standards, as the addition of instrumentation to software that has already been deemed compliant can require that the software is re-certified.

The present disclosure aims to provide an improved method for safety-critical monitoring.

### BRIEF DESCRIPTION OF THE DRAWINGS

Certain embodiments of the disclosure will now be described, by way of example only, with reference to the accompanying drawings, in which:

FIG. 1 is a schematic diagram of the structural architecture of an apparatus comprising a monitoring system according to the present disclosure;

FIG. 2 is a schematic diagram of the functional architecture of the apparatus;

FIGS. 3A and 3B are timelines illustrating the monitoring system checking for temporal consistency under two different scenarios;

FIGS. 4A and 4B are timelines illustrating the monitoring system checking for logical consistency under two different scenarios; and

FIG. 5 is a flow diagram illustrating a method of monitoring a target system according to an embodiment of the present disclosure.

### DETAILED DESCRIPTION OF EMBODIMENTS

A first set of embodiments provides an apparatus comprising a monitoring system for high-integrity monitoring of a safety-critical target system, the monitoring system comprising:
an interface for receiving messages from the target system according to a publish-subscribe communication protocol; and
one or more processors,
   wherein the monitoring system is configured to:
access configuration data representing one or more expected timing characteristics for a succession of messages that are to be published by the target system in accordance with the publish-subscribe communication protocol;
subscribe, using the publish-subscribe communication protocol, to receive the succession of messages;
receive the succession of messages at the interface, wherein each message comprises a respective publication timestamp;
use the configuration data to determine whether the publication timestamps of the received succession of messages are consistent with the one or more expected timing characteristics; and
signal an inconsistency if the publication timestamps of the received succession of messages are not consistent with the one more expected timing characteristics.

Some embodiments provide a non-transitory computer-readable medium storing instructions that, when executed on a monitoring system comprising one or more processors, cause the monitoring system to:
access configuration data representing one or more expected timing characteristics for a succession of messages that are to be published by a target system in accordance with a publish-subscribe communication protocol;
subscribe, using the publish-subscribe communication protocol, to receive the succession of messages;
receive the succession of messages, wherein each message comprises a respective publication timestamp;
   use the configuration data to determine whether the publication timestamps of the received succession of messages are consistent with the one or more expected timing characteristics; and
signal an inconsistency if the publication timestamps of the received succession of messages are not consistent with the one or more expected timing characteristics.

Some embodiments provide a method of high-integrity monitoring of a safety-critical target system, the method comprising:
accessing configuration data representing one or more expected timing characteristics for a succession of messages that are to be published by the target system in accordance with a publish-subscribe communication protocol;
subscribing, using the publish-subscribe communication protocol, to receive the succession of messages;
receiving the succession of messages, wherein each message comprises a respective publication timestamp;
detecting an inconsistency by using the configuration data to determine that the respective publication timestamp of one or more of the received messages is inconsistent with the one or more expected timing characteristics; and
signaling the inconsistency.

Thus it will be seen that, in accordance with at least some embodiments of the disclosure, a safety-critical target system is monitored by a high-integrity monitoring system to determine whether the target system is operating in accordance with configuration data representing one or more expected timing characteristics for a succession of messages that are to be published by the target system, and to signal an inconsistency if not. To achieve this, the monitoring system accesses the configuration data and subscribes to receive the messages using a publish-subscribe protocol. This can allow the monitoring system to conveniently monitor messages that the target system would be publishing anyway as part of its normal operation, rather than requiring the target system to be specially instrumented to send bespoke messages to the monitoring system over a socket-based communication channel. It may also enable the apparatus to make use, for monitoring purposes, of a publish-subscribe communication system that is also used for other purposes, instead of requiring a dedicated socket-based communication channel to be specially provided.

The monitoring system may comprise a memory storing software instructions which, when executed by the one or more processors, cause the monitoring system to perform any step or combination of steps described herein (e.g. any or all of the steps of: accessing configuration data, subscribing to receive the succession of messages, receiving the succession of messages, using the configuration data, and signaling an inconsistency).

The messages are received at an interface of the monitoring system, and the configuration data is used to determine whether publication timestamps of the received messages are consistent with the one or more expected timing characteristics in the configuration data. If the publication timestamps are not consistent with the expected timing characteristics, an inconsistency is signaled.

The succession of messages may be issued by software executing on the target system or may be issued by hardware circuitry. The target system may comprise one or more processors and a memory storing software instructions for execution by the one or more processors. The target system may execute one or more safety-critical software applications. The target system may be a functionally safe system.

The monitoring system may be a high-integrity monitoring system. It may be of a higher integrity than the target system. For example, the one or more processors of the monitoring system may be higher-integrity than a processor of the target system, e.g. they may have greater fault tolerance than the processors of the target system. The one or more processors of the monitoring system may be configured to support lockstep execution, and the monitoring system may be configured to execute the software instructions on the one or more processors using lockstep execution. In some embodiments, the one or more processors of the monitoring system may be functionally safe processors, e.g. they may operate in accordance with the ISO 26262 functional safe standard.

The succession of messages that are to be published by the target system may comprise messages for one or more recipient systems that are distinct from the monitoring system. Each recipient system may be configured to subscribe, using the publish-subscribe communication protocol, to receive the succession of messages. Each recipient system may be part of the apparatus or may be separate therefrom. The messages published by the target system may thus be received by one or more further systems in addition to the monitoring system. In some embodiments, the messages published by the target system are received by one or more further systems in addition to the monitoring system. For example, the messages published by the target system may be intended for a peripheral, such as a sensor, and may contain operating instructions for the peripheral. The monitoring system may thus be able to receive messages using the publish-subscribe communication protocol that are not primarily intended for the monitoring system. In this way, the monitoring system can monitor the target system without requiring dedicated signaling to be provided between the target system and the monitoring system.

The apparatus may comprise the target system. It may comprise a publish-subscribe communication system. The publish-subscribe communication system may be arranged to implement the publish-subscribe communication protocol, and to interface with the target system and with the monitoring system. It may additionally interface with one or more recipient system. The publish-subscribe communication system may comprise one or more physical interconnects, e.g. buses or network connections, which may be electrical and/or optical. In some embodiments, the publish-subscribe communication system may comprise middleware (e.g. a software layer within each of the monitoring system and the target system) that implements the publish-subscribe communication protocol. In some embodiments, the publish-subscribe communication system may comprise an intermediary message broker configured to route messages between the target system and the monitoring system. However, in some embodiments, the publish-subscribe communication protocol may operate according to a brokerless architecture, e.g. it may implement a multicast-based discovery protocol.

The apparatus may be a data processing apparatus. The apparatus may be or may comprise an integrated-circuit device that integrates the monitoring system with the target system and the publish-subscribe communication system (and optionally one or more recipient systems). However, this may not be the case in all embodiments, and in some embodiments the monitoring system, target system and publish-subscribe communication system may be provided as a distributed system. In some embodiments, the monitoring system and the target system may each be implemented by a different respective integrated circuit (e.g. a chiplet), which may be implemented together in a common package.

In some embodiments, the target system is configured to publish the succession of messages in response to signals received from one or more sensors of, or communicably coupled to, the target system. In some such embodiments, the one or more sensors comprise sensors for use in an automated (e.g. autonomous) driving system or vehicle. The one or more sensors may comprise, for example, a camera sensor, LIDAR sensor, or a radar sensor, or an ultrasonic sensor, or any other sensor arranged to sense objects in the proximity of a vehicle in which the automated driving system is implemented.

The one or more expected timing characteristics may wholly or partly determine an expected publication time for each message of the succession. The monitoring system may be configured determine an expected publication time for each message of the succession at least partly in dependence upon the configuration data.

The target system may be configured to publish the messages of the succession of messages according to a predetermined pattern, e.g. depending on the requirements of one or more recipient systems. The target system may be configured to publish the messages periodically. For example, in some embodiments, in which the published messages comprise messages for a recipient camera sensor, the target system may be configured to publish the messages at 30 Hz, i.e. every 3.33 milliseconds. However, the target system may be configured to publish messages at any appropriate frequency, or aperiodically, depending on the requirements of the recipient system. In some embodiments, the target system may be configured to publish messages every N microseconds or N milliseconds, e.g. where N is at least 1, 10 or 100 and/or where N is at most 10, 100 or 1000. In some embodiments, the one or more expected timing characteristics may comprise an expected period or frequency of publication of the succession of messages, and the monitoring system may be configured to determine whether the publication timestamps of the received succession of messages are consistent with the expected period or frequency of publication.

The messages of the succession may all be of a same message type or they may be of different types. The target system may publish one or more further successions of messages (e.g. of different respective types, or having different respective periods or frequencies); these may be at least partially interleaved in time with the first succession of messages. The configuration data may further represent expected timing characteristics for the one or more further successions of messages—e.g. a respective period or frequency of publication of the respective succession.

The target system may be configured to operate in any one of a plurality of operating modes, and the one or more expected timing characteristics for the succession of messages may be dependent upon which of the plurality of operating modes the target system is in when the succession of messages are published. For example, the target system may comprise a processor implemented in an automated (e.g. autonomous) vehicle, which may operate in different states depending on the actions being taken by an automated driving system of the vehicle. In some such embodiments, the target system may be configured to operate in a first operating mode when the automated vehicle is moving above a threshold speed, and may be configured to operate in a second operating mode when a speed of the automated vehicle is no greater than the threshold speed. In some examples, the threshold may be zero. The target system may be configured to publish messages (e.g. to provide instructions to one or more sensors) at a higher frequency in the first (higher-speed) operating mode, and to publish messages at a lower frequency in the second (lower-speed) operating mode.

In some embodiments, the configuration data may represent one or more respective expected timing characteristics for the succession of messages for each of the plurality of operating modes. The monitoring system may be configured to determine in which of a plurality of operating modes the target system is operating and to determine whether the publication timestamps of the received succession of messages are consistent with the expected timing characteristics for the determined operating mode. The monitoring system may determine the operating mode in which the target system is operating, and determine the one or more expected timing characteristics for the succession of messages based on the determined operating mode. The expected timing characteristics for the operating mode may then be used when determining whether the publication timestamps are consistent with the one or more expected timing characteristics.

In some embodiments, determining, by the monitoring system, whether the publication timestamps of the received succession of messages are consistent with the one or more expected timing characteristics of the succession of messages comprises the monitoring system determining, for each message of the succession of messages, whether the publication timestamp of the message is within a tolerance of an expected publication time for the respective message. The tolerance may determine a time window containing the expected publication time. The expected publication time may be centered in the time window (e.g. within ±100 microseconds of the expected publication time, or it may be offset (e.g. within −90 microseconds to +10 microseconds of the expected publication time). In some examples, the tolerance may allow a message to be received earlier than the expected publication time but not later. A publication timestamp may be determined as being consistent with the expected timing characteristics if it has a publication timestamp that is within the time window.

In some embodiments, the configuration data encodes a tolerance for the publication timestamps. This may allow an individual tolerance to be set for each of the publication timestamps individually. For example, certain messages may need to be published within a narrow time window to satisfy a safety-critical condition, necessitating a low tolerance, whereas other messages may be less critical, such that a higher tolerance may be sufficient. However, in some embodiments, one or more global tolerance values may be stored in the memory of the monitoring system, and be used for multiple publication timestamps, e.g. for all or a subset of the publication timestamps.

In some embodiments, the monitoring system may be configured to determine whether the publication timestamps of the received succession of messages are consistent with expected publication times that are determined in dependence upon when a first message of the succession was published. In such embodiments, no timing drift is permitted. However, in some embodiments, the monitoring system may be configured to determine whether the publication timestamps of the received succession of messages are consistent with expected publication times that depend, for all but the first message of the succession, upon when an immediately preceding message of the succession was published—e.g., determining whether each message is published with an expected delay from an immediately preceding message (e.g. between 900 microseconds and 10,100 microseconds thereafter). At least in some such embodiments, timing drift may be allowed, although optionally only a drift towards earlier publication times.

The monitoring system may be configured to use the configuration data to determine whether an order of received messages (e.g. within one or more successions of messages) is consistent with an expected order derived from the configuration data, and to signal an inconsistency when the order of the received messages is not consistent with the expected order. Determining the consistency of the order of the messages may be performed independently of determining the consistency of the publication timestamps with the one or more expected timing characteristics. By monitoring the order of received messages, as well as their timing characteristics, the monitoring system may determine whether the order of the received messages is consistent with an expected order, and thereby identify and flag logical issues in the target system.

The monitoring system may be configured to signal an inconsistency in the timing and/or ordering of the received messages in any appropriate way. In some embodiments, the monitoring system may be configured to signal an inconsistency by publishing an error message using the publish-subscribe communication protocol. This may be received by systems subscribed to receive messages published by the monitoring system. However, in some embodiments the monitoring system may be configured to signal an inconsistency by outputting a signal, e.g. to the target system or a separate a fault management system. This may allow the target system or fault management system to take steps to address issues that may be caused as a result of the inconsistency. For example, the target system may be configured to output a signal to one or more control systems, such as a control system of a vehicle, in response to the inconsistency being configured, e.g. to bring the vehicle to a safe stop.

The configuration data may be stored in a memory of the monitoring system. Accessing the configuration data may comprise reading the configuration data from a memory of the monitoring system or may comprise receiving the configuration data from outside the monitoring system. In some embodiments, the monitoring system may be configured to receive the configuration data, using the publish-subscribe communication protocol, from the target system or from one or more further systems. In this way, the configuration data may be modified or updated by the target system or the one or more further systems before being accessed by the monitoring system. This may allow updated configuration data to be provided to the monitoring system in the case that the target system is reconfigured to publish messages having different expected timing characteristics to an initial set of expected timing characteristics. However, in some embodiments the monitoring system may be configured to access the configuration data by alternative means, e.g. over a bus between the monitoring system the target system. In some embodiments the configuration data may be pre-loaded in the monitoring system, e.g. in situations where the messages to be published by the target system are defined in advance and cannot be updated over time.

In some embodiments, the monitoring system is configured to monitor multiple target systems concurrently.

In some embodiments, the configuration data may additionally represent one or more expected timing characteristics for a second succession of messages that are to be published by the target system or by a further target system, wherein the second succession of messages at least partially overlaps in time with the aforesaid succession of messages published by the target system. In some such embodiments, wherein the monitoring system may be further configured to:
subscribe, using the publish-subscribe communication protocol, to receive the second succession of messages,
receive the second succession of messages, at least partially overlapping in time with the aforesaid succession of messages published by the target system, wherein each message comprises a respective publication timestamp;
use the configuration data to determine whether the publication timestamps of the received second succession of messages are consistent with the one or more expected timing characteristics for the second succession of messages; and
signal an inconsistency if the publication timestamps of the received second succession of messages are not consistent with the one or more expected timing characteristics for the second succession of messages.

The second succession of messages may be published periodically.

In some embodiments, the publish-subscribe communication protocol is a Data Distribution Service (DDS) protocol according to an Object Management Group (OMG) standard. In some such embodiments, the target system may be configured to publish messages to one or more topics of a DDS messaging system as instances of a topic according to a version of the DDS specification. The monitoring system may be configured to subscribe to one or more topics of the DDS messaging system so as to receive messages published by the target system. The target system may thus be a data writer according to a version of the DDS specification and the monitoring system may be a data reader according to a version of the DDS specification. In some alternative embodiments, the publish-subscribe communication protocol is a SOME/IP protocol. In some further alternative embodiments, the publish-subscribe communication protocol is a DDS protocol provided using the Connext framework provided by Real-Time Innovations.

In some embodiments, the target system and/or one or more recipient systems may be within an automotive vehicle, and the monitoring may be performed by a monitoring system within the automotive vehicle.

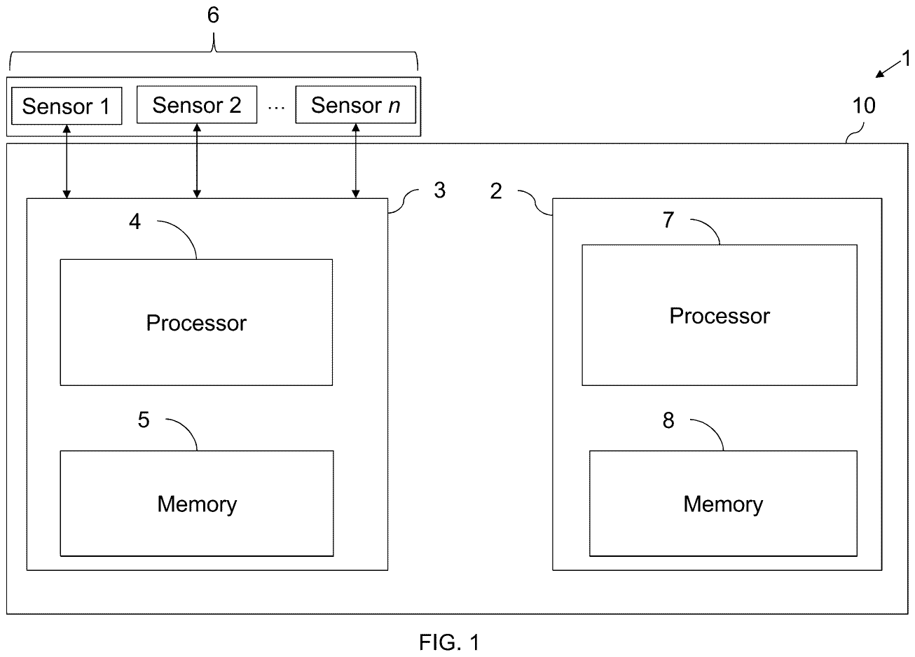

FIG. 1 shows the structural architecture of an exemplary apparatus 1 for use within an automated (e.g. autonomous) vehicle, It comprises an integrated circuit package 10 comprising a target system 3 and a monitoring system 2 for monitoring the target system 3. The apparatus 1 also includes a set of n sensors 6 communicatively coupled to the target system 3. The sensors 6 may include sensors for monitoring a state of the vehicle and/or for monitoring an environment in the vicinity of a vehicle in which the monitoring system is employed, such as a LIDAR sensor, a radar sensor, an ultrasonic sensor, etc.

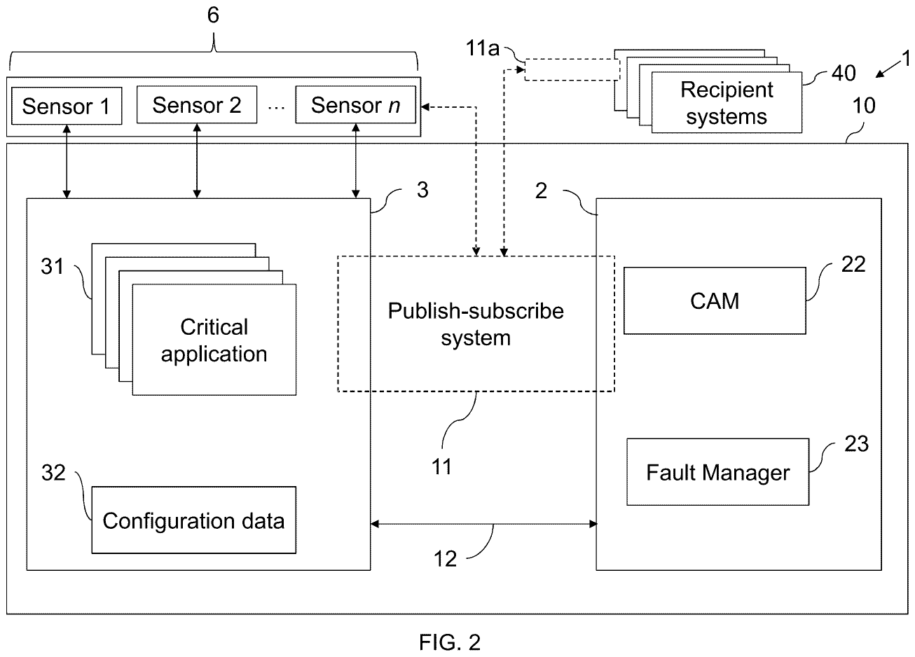

The target system 3 comprises a high-performance processor 4 arranged to receive inputs from, and provide outputs to, the plurality of sensors 6, and a memory 5 storing instructions for execution by the processor 4. As explained below in relation to FIG. 2, the processor 4 of the target system 3 is configured to run one or more safety-critical software applications which may process data stored in the memory 5 and/or data from one or more of the sensors 6. For example, one of the safety-critical applications run by the target processor may be configured to receive LIDAR data from one of the sensors 6 at a predetermined rate, and to process the LIDAR data to determine whether an object is present in the vicinity of the sensor 6.

The monitoring system 2 is provided as a safety island, i.e., as a independent compute sub-system, separate from the target system 3. It provides a higher safety-level compute area for monitoring applications running on the target system 3. The monitoring system 2 comprises a high-integrity processor 7 (e.g. a fault tolerant processor supporting lockstep execution) configured to execute instructions stored in a memory 8. These include a monitoring application for monitoring the target system 3.

FIG. 2 schematically illustrates the functional architecture provided by the hardware and software of the apparatus 1, as well as one or more optional recipient system.

The target system 3 is configured to run a set of one or more safety-critical applications 31, each of which is configured to execute a set of tasks. At least some of these tasks may be performed periodically in normal operation. They may be chained together to produce a feature pipeline for the respective application 31. Whenever one of these tasks is executed by a safety-critical application 31, a corresponding event message is published by the target system 3 to a publish-subscribe communication system 11, for receipt by one or more recipient systems 4. The recipient systems 4 may be provided by software and/or hardware on the integrated circuit package 10, or they may be located remotely from the integrated circuit package 10 (e.g. elsewhere in the vehicle), or a combination of both. The publish-subscribe communication system 11 may include one or more components 11a that are located off the integrated circuit package 10.

In the embodiment shown in FIG. 2, the publish-subscribe communication system 11 comprises a middleware software layer implemented within the target system 3 and the monitoring system 2, as well as optionally within one or more further optional off-chip components 11a. It may operate in accordance with the OMG Data Distribution Service (DDS) protocol or a SOME/IP protocol, or any other suitable publish-subscribe protocol.

Messages are published by the target system 3 each time one of the periodic tasks is executed by a safety-critical application 31. They encode data relating to or resulting from a task performed by the safety-critical application 31, for receipt by a recipient system 6, 40. In addition to this data, each message includes a publication timestamp encoding the time at which the task was completed and/or published by the critical application 31 (e.g. in the form of the write time of the published message). Each safety-critical application 31 and/or each task may publish a respective succession of messages, which may be collectively received as a stream of messages by the monitoring system 2.

The target system 3 is also configured to store configuration data 32 defining the tasks to be performed by the safety-critical applications 31. More specifically, the configuration data 32 defines, for each safety-critical application 31, expected timing characteristics for one or more sets of tasks to be executed by the safety-critical application 31. This could, in some embodiments, comprise a complete schedule of excepted publication times for a finite succession of messages, i.e. encoding an absolute publication time for each message; however, in other embodiments, it comprises a value encoding an expected period or frequency of publication of a succession of messages (e.g. “every 10 milliseconds”, or “every 1,000 milliseconds”). The timings may depend on what function(s) is performed by the respective safety-critical application 31. The configuration data 32 can represent expected publication timings for messages to be published to the publish-subscribe communication system 11 by the target system 3 as a result of tasks being completed by a safety-critical application 31.

In addition to the expected publication times, the configuration data 32 may encode a timing tolerance for each set of messages, e.g. in the form of an acceptable publication time window, e.g., within ±100 microseconds of an expected publication time. The acceptable publication window will be use-case dependent in practice, and may be greater or smaller than 100 microseconds in some embodiments. When a message is published by the target system 3 outside of an expected publication time to which this tolerance has been applied, it can be determined by the monitoring system 2 that a corresponding critical application 31 is not functioning correctly. The configuration data may thus be used by the monitoring system 2 to determine whether the critical applications 31 are running as intended, as explained in more detail below.

The monitoring system 2 may check for precise consistency against a set of absolute publication times (e.g. determined relative to when the very first message of a succession of message is published), or it may check for consistency against relative times that are determined partly upon when each preceding message is published. This latter approach may allow for some timing drift, e.g. if the system is not accurately synchronized. However, in many embodiments, the system will be synchronized. The monitoring system 2 may support both modes of timing, e.g. with the mode being set by the configuration data.

Messages that are published to the publish-subscribe communication system 11 by the target system 3 can be received by any system 2, 6, 40 that has subscribed to receive said messages from the publish-subscribe communication system 11 using the publish-subscribe communication protocol. For example, when using the DDS protocol, messages published to the publish-subscribe communication system 11 by the target system are published as instances (e.g. values) of topics (e.g. temperature or pressure) to which systems may subscribe. The topic to which the instance is published depends on the nature of the task performed by the critical application in response to which the message was published. Systems can subscribe to a range of topics, such that, when messages are published as instances of that topic, the messages are received at all systems subscribed to that topic.

Based on the content of a message received using the publish-subscribe communication system 11, a recipient system 6, 40 may determine its behavior, e.g. by performing a set of operations in response to the received message. For example, a message published after a task is executed by a safety-critical application 31 may be received by a recipient system 40 using the publish-subscribe communication protocol. The recipient system 40 may process data contained in the received message, and begin performing a new task in response. In a similar way, a message published as a result of a task being executed by a safety-critical application 31 may be received by a sensor 6, which may modify its behavior based on the received message, e.g. a sensor 6 may begin sensing in response to a received message, or may adapt one or more sensing parameters (e.g. a measurement frequency) based on the received message.

The monitoring system 2 is configured to subscribe to receive at least some of the messages published to the publish-subscribe communication system 11 by the target system 3, such that tasks performed by the safety-critical applications 31 can be monitored using the monitoring system 2. This allows the monitoring system 2 to monitor the critical applications 31 running on the target system 3 without the requiring that the critical applications 31 themselves be instrumented to communicate specifically with the monitoring system 2, e.g. using a dedicated application programming interface (API).

To allow monitoring to be performed, the monitoring system 2 is also configured to access the configuration data 32 stored in the target system 3, in order to compare expected timing characteristics comprising expected message publication timings stored in the configuration data with the publication timestamps of messages that are actually published to the publish-subscribe communication system 11 by the target system 3. In the embodiment shown in FIG. 2, the monitoring system 2 is configured to access the configuration data 32 over a local bus 12 between the target system 3 and the monitoring system 2. However, the monitoring system could in other embodiments be configured to access the configuration data 32 using the publish subscribe communication system 11, e.g., configuration data 32 may be published by the target system 3 to a DDS topic to which the monitoring system 2 is subscribed.

The monitoring system 2 subscribes to topics to which the target system 3 is configured to publish messages in response to tasks performed by the safety-critical applications 31. The monitoring system 2 may determine which topics to subscribe to based on the configuration data 32, or in any other suitable way. Having subscribed to the topics, the monitoring system 2 receives messages published to the publish-subscribe communication system 11. The received messages are provided to a critical application monitoring (CAM) application 22 running on the monitoring system 2, which operates to determine whether the safety-critical applications 31 are operating in accordance with the configuration data 32. To do this, the CAM application 22 is configured to extract publication timestamps from messages received over the publish-subscribe communication system 11, and to compare the extracted publication timestamps with the expected timing characteristics (and optionally tolerances) encoded in the configuration data 32.

Based on the comparison, the CAM application 22 determines whether the publication timestamps of the received succession of messages are consistent with the expected timing characteristics defined in the configuration data 32. The comparison performed by the CAM application 22 may be arranged to identify one or both of two classes of issue in the running of the safety-critical applications 31 on the target system 3: temporal issues, e.g. events occurring outside of an expected period; and logical issues, e.g. events occurring outside of an expected order.

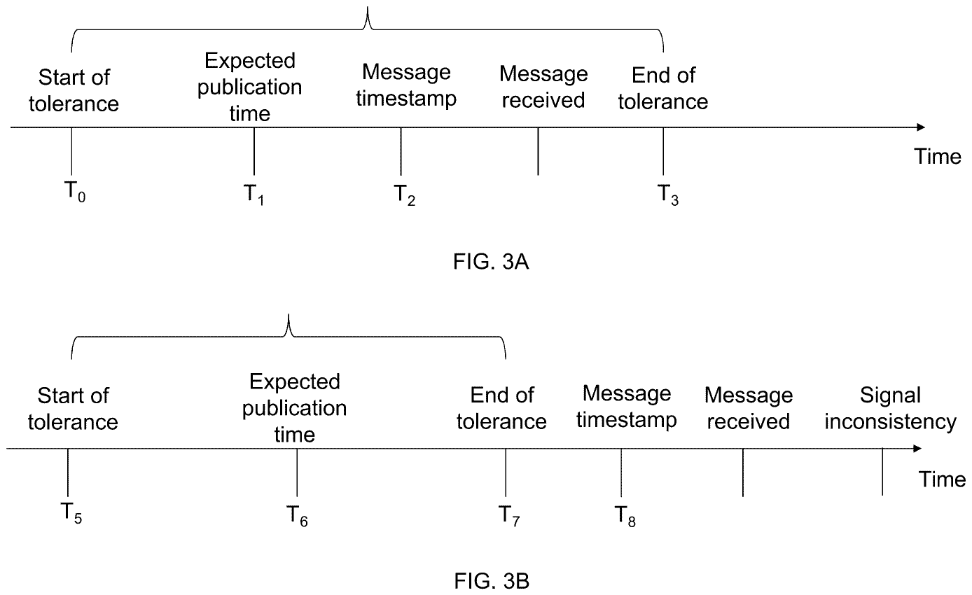

FIGS. 3A and 3B show an example of identifying a temporal issue relating to a safety-critical application 31 using the CAM application 22.

FIG. 3A shows an example of the CAM application 22 monitoring a safety-critical application 31 that is operating in a way that is consistent with the configuration data 32. In the example shown in FIG. 3A, the monitoring system 2 determines from the configuration data (and optionally from the publication times of one or more earlier messages) that a message will be published at a time T1. The monitoring system 2 applies a tolerance, defining an acceptable publication window between a time T0 and a time T3. In this example, prior to the time T3, a message is received by the CAM application 22, with a publication timestamp indicating that the task, in response to which the message was published, was completed at a time T2. The CAM application 22 determines that the time T2 is within the tolerance set in the configuration data (i.e. between T0 and T3), and no inconsistency is signaled.

FIG. 3B shows an example of the CAM application 22 monitoring a safety-critical application 31 that is operating in a way that is not consistent with the configuration data 32. In the example shown in FIG. 3B, the monitoring system 2 determines from the configuration data (and optionally from the publication times of one or more earlier messages) that a message will be published at a time T6. The monitoring system 2 applies a tolerance, defining an acceptable publication window between a time T5 and a time T7. However, at the time T7, no message has been received by the CAM application 22. The message is eventually received at the CAM application 22, with a publication timestamp indicating that the associated task was completed at a time T8 which is after the time T7. The CAM application 22 determines that the message was not received within the tolerance and signals an inconsistency.

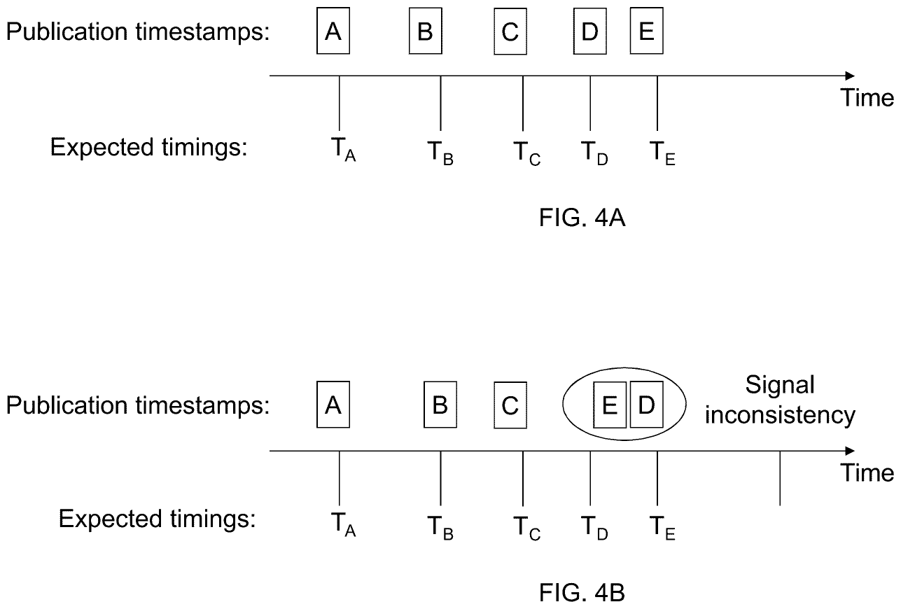

FIGS. 4A and 4B show an example of identifying a logical issue relating to a safety-critical application 31 using the CAM application 22.

In the example shown in FIGS. 4A and 4B, the monitoring system 2 determines from the configuration data that a stream of messages A-E are expected to be published at respective times TA-TE. The stream may be a single periodic succession of messages published by one safety-critical application 31, or it may comprise a plurality of successions of messages, e.g. from different safety-critical applications 31 and/or from different target systems. The expected publication times may be determined in advance of receiving any of the messages A-E, or dynamically as the messages are received. In the example shown in FIGS. 4A and 4B, it is assumed that all the messages are published within their respective tolerances, so no temporal issue is detected. However, in this example, the configuration data also encodes an expected publication order of messages to be published by the target system 3, and the CAM application 22 is configured to signal an inconsistency in the event that the order of published messages is not consistent with the expected order encoded in the configuration data 32. For example, in some situations, a first process might have to finish before a second process starts in order to guarantee correct behavior; the configuration data may specify this and the CAM application 22 can then check this requirement is met.

FIG. 4A shows an example of the CAM application 22 monitoring a safety-critical application 31 that is operating in a way that is consistent with the configuration data 32. The order of the received messages is the same as that encoded in the configuration data and so the CAM application 22 determines that there is no inconsistency.

FIG. 4B shows an example of the CAM application 22 monitoring a safety-critical application 31 that is operating in a way that is not logically consistent with the configuration data 32. The publication timestamps of the messages A-C are received in the order determined from the configuration data 32, but message E is received prior to message D, which is not in accordance with the configuration data 32. The CAM application 22 thus determines that the order of the received messages is not consistent with the expected order in the configuration data 32 and signals an inconsistency in response.

Thus, as illustrated in FIGS. 3 and 4, the monitoring system 2 is able to determine whether the publication timestamps of messages published by the target system 3 are both temporally and logically consistent with expected timing characteristics defined in the configuration data 32. If the publication timestamps of the received messages are not consistent with the expected timing characteristics in the configuration data 32, it is inferred that one or more of the critical applications 31 is not operating as expected, and an inconsistency is signaled accordingly.

An inconsistency may be signaled by the CAM application 22 providing an output to a fault manager 23, which takes further action depending on the nature of the inconsistency identified. Additionally or alternatively, in some embodiments, the CAM application 22 may cause the monitoring system 2 to publish a message to the publish-subscribe communication system 11 that can be received by any system subscribed to receive messages published by the monitoring system, e.g. one or more of the sensors 6, the target system 3 or another recipient system 40.

The monitoring system 2 is therefore able to monitor a target system 3, and to signal an inconsistency if one or more safety-critical applications 31 running on the target system 3 are not operating as intended.

The monitoring system 2 may similarly monitor one or more further target systems, which may or may not be located on the same integrated circuit package 10. It may access respective configuration data for each target system, or the same configuration data may encode expected timing characteristics for all of the target systems.

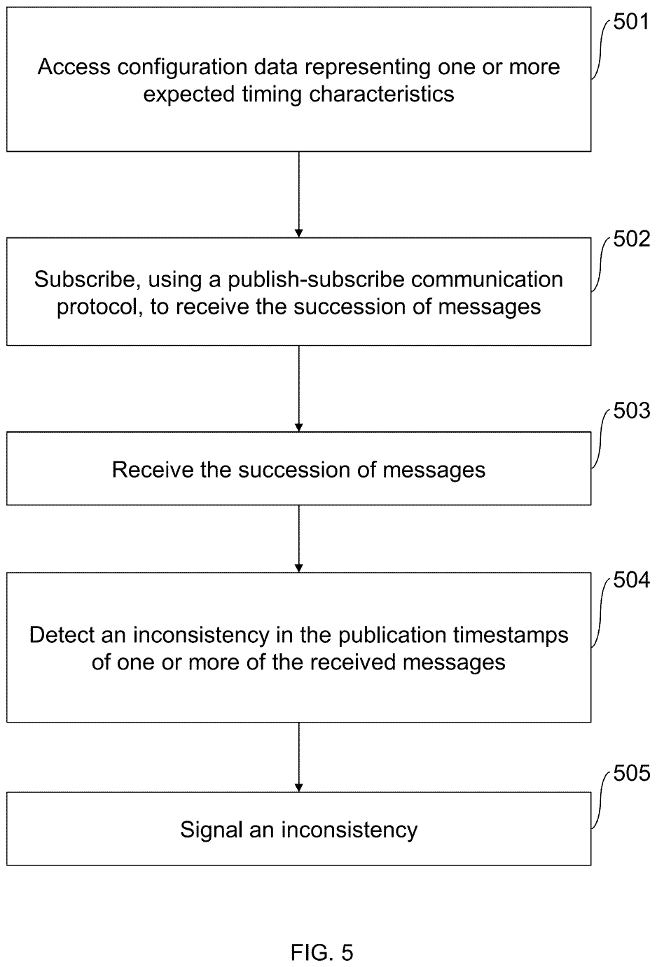

This process is summarized in FIG. 5, which shows a flow diagram illustrating a method of monitoring a target system according to an embodiment of the present disclosure.

In step 501, configuration data is accessed, representing one or more expected timing characteristics for a succession of messages that are to be published by the target system in accordance with a publish-subscribe communication protocol.

In step 502, the method comprises subscribing, using the publish-subscribe communication protocol, to receive the succession of messages.

In step 503, the succession of messages are received, each message comprising a respective publication timestamp.

In step 504, an inconsistency is detected by processing the configuration data to determine that the respective publication timestamp of one or more of the received messages is inconsistent with the one or more expected timing characteristics.

As a result of this determination, an inconsistency is signaled in step 505.

It will be appreciated that the present disclosure presents various specific embodiments, but is not limited to these embodiments; many variations and modifications are possible, within the spirit and scope of the disclosure.

We claim:

1. An apparatus comprising a monitoring system for high-integrity monitoring of a safety-critical target system, the monitoring system comprising:
an interface for receiving messages from the target system according to a publish-subscribe communication protocol; and
one or more processors,
wherein the monitoring system is configured to:
access configuration data representing one or more expected timing characteristics for a succession of messages that are to be published by the target system in accordance with the publish-subscribe communication protocol;
subscribe, using the publish-subscribe communication protocol, to receive the succession of messages;
receive the succession of messages at the interface, wherein each message comprises a respective publication timestamp;
use the configuration data to determine whether the publication timestamps of the received succession of messages are consistent with the one or more expected timing characteristics; and
signal an inconsistency if the publication timestamps of the received succession of messages are not consistent with the one or more expected timing characteristics.

2. The apparatus of claim 1, wherein the monitoring system is of a higher integrity than the target system.

3. The apparatus of claim 1, wherein the one or more processors of the monitoring system are configured to support lockstep execution, and wherein the monitoring system is configured to execute software instructions on the one or more processors using lockstep execution.

4. The apparatus of claim 1, wherein the succession of messages that are to be published by the target system further comprise instructions for a recipient system other than the monitoring system, the recipient system being configured to subscribe, using the publish-subscribe communication protocol, to receive the succession of messages.

5. The apparatus of claim 1, further comprising:
the target system; and
a publish-subscribe communication system,
wherein the publish-subscribe communication system is arranged to implement the publish-subscribe communication protocol, and to interface with the target system and with the monitoring system.

6. The apparatus of claim 5, wherein the apparatus is an integrated-circuit device that integrates the monitoring system with the target system and the publish-subscribe communication system.

7. The apparatus of claim 5, wherein the target system is configured to publish the succession of messages in response to signals received from one or more sensors of, or communicably coupled to, the target system.

8. The apparatus of claim 1, wherein:
the target system is configured to publish the messages of the succession of messages periodically;
the configuration data represents the one or more expected timing characteristics as an expected period or frequency of publication of the succession of messages; and
the monitoring system is configured to determine whether the publication timestamps of the received succession of messages are consistent with the expected period or frequency of publication.

9. The apparatus of claim 1, wherein:
the target system is configured to operate in any one of a plurality of operating modes, wherein the one or more expected timing characteristics for the succession of messages are dependent upon which of the plurality of operating modes the target system is in when the succession of messages is published;
the configuration data represents one or more respective expected timing characteristics for the succession of messages for each of the plurality of operating modes;
the monitoring system is configured to determine in which of the plurality of operating modes the target system is operating; and
the monitoring system is configured to determine whether the publication timestamps of the received succession of messages are consistent with the one or more expected timing characteristics for the determined operating mode.

10. The apparatus of claim 1, wherein determining, by the monitoring system, whether the publication timestamps of the received succession of messages are consistent with the one or more expected timing characteristics for the succession of messages comprises determining, for each message of the succession of messages, whether the publication timestamp of the message is within a tolerance of an expected publication time for the respective message.

11. The apparatus of claim 10, wherein the configuration data encodes a respective tolerance for each of the publication timestamps.

12. The apparatus of claim 1, wherein the configuration data encodes an expected order of the succession of messages, and wherein the monitoring system is further configured to:
use the configuration data to determine whether an order of the received succession of messages is consistent with the expected order encoded by the configuration data, and
signal an inconsistency when the order of the received succession of messages is not consistent with the expected order encoded by the configuration data.

13. The apparatus of claim 1, wherein the monitoring system is configured to signal an inconsistency by publishing an error message using the publish-subscribe communication protocol.

14. The apparatus of claim 1, wherein the monitoring system is configured to receive the configuration data, using the publish-subscribe communication protocol, from the target system or from one or more further systems.

15. The apparatus of claim 1, wherein the configuration data additionally represents one or more expected timing characteristics for a second succession of messages that are to be published by the target system or by a further target system, wherein the second succession of messages at least partially overlaps in time with the aforesaid succession of messages published by the target system, and wherein the monitoring system is further configured to:
subscribe, using the publish-subscribe communication protocol, to receive the second succession of messages;
receive the second succession of messages, at least partially overlapping in time with the aforesaid succession of messages published by the target system, wherein each message comprises a respective publication timestamp;
use the configuration data to determine whether the publication timestamps of the received second succession of messages are consistent with the one or more expected timing characteristics for the second succession of messages; and
signal an inconsistency if the publication timestamps of the received second succession of messages are not consistent with the one or more expected timing characteristics for the second succession of messages.

16. The apparatus of claim 1, wherein the publish-subscribe communication protocol is a Data Distribution Service (DDS) protocol or a SOME/IP protocol.

17. A non-transitory computer-readable medium storing instructions that, when executed on a monitoring system comprising one or more processors, cause the monitoring system to:
access configuration data representing one or more expected timing characteristics for a succession of messages that are to be published by a safety-critical target system in accordance with a publish-subscribe communication protocol;
subscribe, using the publish-subscribe communication protocol, to receive the succession of messages;
receive the succession of messages, wherein each message comprises a respective publication timestamp;
use the configuration data to determine whether the publication timestamps of the received succession of messages are consistent with the one or more expected timing characteristics; and
signal an inconsistency if the publication timestamps of the received succession of messages are not consistent with the one or more expected timing characteristics.

18. The non-transitory computer-readable medium of claim 17, wherein determining whether the publication timestamps of the received succession of messages are consistent with the one or more expected timing characteristics for the succession of messages comprises determining, for each message of the succession of messages, whether the publication timestamp of the message is within a tolerance of an expected publication time for the respective message.

19. A method of high-integrity monitoring of a safety-critical target system, the method comprising:
accessing configuration data representing one or more expected timing characteristics for a succession of messages that are to be published by the target system in accordance with a publish-subscribe communication protocol;
subscribing, using the publish-subscribe communication protocol, to receive the succession of messages;
receiving the succession of messages, wherein each message comprises a respective publication timestamp;
detecting an inconsistency by using the configuration data to determine that the respective publication timestamp of one or more of the received messages is inconsistent with the one or more expected timing characteristics; and
signaling the inconsistency.

20. The method of claim 19, wherein the target system is within an automotive vehicle, and wherein the monitoring is performed by a monitoring system within the automotive vehicle.
